(19) United States
(12) Patent Application Publication
(10) Pub. No.: US 2010/0238551 A1
(43) Pub. Date: Sep. 23, 2010

(54) SURGICAL MICROSCOPE DRAPE LENS FOR REDUCING GLARE

(76) Inventor: Charles M. Hubbs, Baton Rouge, LA (US)

Correspondence Address: PERKINS COIE LLP, POST OFFICE BOX 1208, SEATTLE, WA, 98111-1208, US

(21) Appl. No.: 12/407,102

(22) Filed: Mar. 19, 2009

(51) Int. Cl. G03B 11/04; G02B 27/00

(52) U.S. Cl. 359/510; 359/601

(57) ABSTRACT

A lens drape for a surgical microscope includes a drape and a lens assembly attached to the drape. The lens assembly includes a drape ring and a lens ring holding a lens. The drape is attached to the drape ring. The lens ring holds the lens at an acute angle. The lens ring is also rotatable on the drape ring. The angle of the lens, and the ability to rotate the lens, allows for reduction of glare during surgery performed using a microscope.

### BACKGROUND OF THE INVENTION

Surgical microscope drapes prevent infection by providing a physical barrier between a non-sterile surgical microscope and the patient. Since the objective lens of the surgical microscope is generally directly above the open surgical site in the patient, preventing movement of particles, liquids or aerosols from the microscope to the patient is essential to prevent infection. The drape also prevents contaminants from moving from the patient onto the microscope. Since the microscope is used over and over, and is difficult or impossible to completely sterilize, preventing contamination of the microscope is also an important function of the drape.

Surgical microscopes are typically used with bright operating room lights directed downwardly onto the surgical site. Some microscopes also include internal lighting directed through the objective lens. The lighting can result in glare, making it more difficult for the surgeon to see the surgical site. To reduce glare, surgical microscope drapes have been provided with a drape lens or window positioned at an acute angle to horizontal. The angle of the microscope drape lens tends to reduce glare by directing reflected light away from the objective lens of the microscope. However, even with these types of microscope drape lenses, glare can still make it difficult to clearly see the surgical site through the microscope. Accordingly, improved designs and methods are needed.

### SUMMARY OF THE INVENTION

In one aspect of the invention, the lens in a microscope lens drape is oriented at a non-perpendicular angle to the axis of the objective lens of the microscope, and the drape lens is also rotatable relative to the objective lens. This allows the drape lens to be rotated to any preferred angle, to reduce glare.

The present lens drape includes a drape and a lens assembly attached to the drape. The lens assembly includes a drape ring and a lens ring holding a lens. The drape is attached to the drape ring. The lens ring holds the lens at an acute angle. The lens ring is also rotatable on the drape ring. The angle of the lens, and the ability to rotate the lens, allows for reduction of glare during surgery.

Other and further objects and advantages will appear from the following detailed description which describes one embodiment of the design. The detailed description is provided however by way of example, and not to describe the limits of the invention.

### BRIEF DESCRIPTION OF THE DRAWINGS

In the drawings, the same element number indicates the same element, in each of the views.

FIG. 1 is a perspective view of the present microscope drape.

FIG. 1A is an exploded perspective view of the lens assembly shown in FIG. 1.

FIG. 2 is a top view of the drape shown in FIG. 1.

FIG. 3 is a back view of the drape shown in FIG. 1.

FIG. 4 is a side view of the drape shown in FIG. 1.

FIG. 5 is a front view of the drape shown in FIG. 1.

FIG. 6 is a bottom view of the drape shown in FIG. 1.

FIG. 7 is a top view of the drape ring shown in FIGS. 3-5.

FIG. 8 is a section view taken along line 8-8 of FIG. 7.

FIG. 9 is a bottom view of the drape ring shown in FIGS. 7 and 8.

FIG. 10 is a top view of the lens ring shown in FIGS. 1-5.

FIG. 11 is a side view of the lens ring shown in FIG. 10.

FIG. 12 is a section view taken along line 12-12 of FIG. 10.

FIG. 13 is a top view of the lens ring shown in FIGS. 10-12.

FIG. 14 is a bottom view of the lens shown in FIGS. 1-2.

FIG. 15 is a front view of the lens shown in FIG. 15.

FIG. 16 is a top view of the lens shown in FIGS. 14-15.

FIG. 17 is side view of the lens shown in FIGS. 14-16.

### DETAILED DESCRIPTION OF THE DRAWINGS

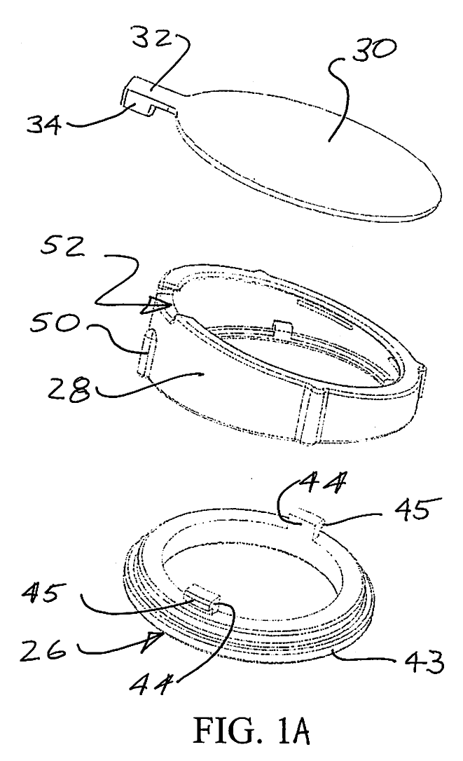

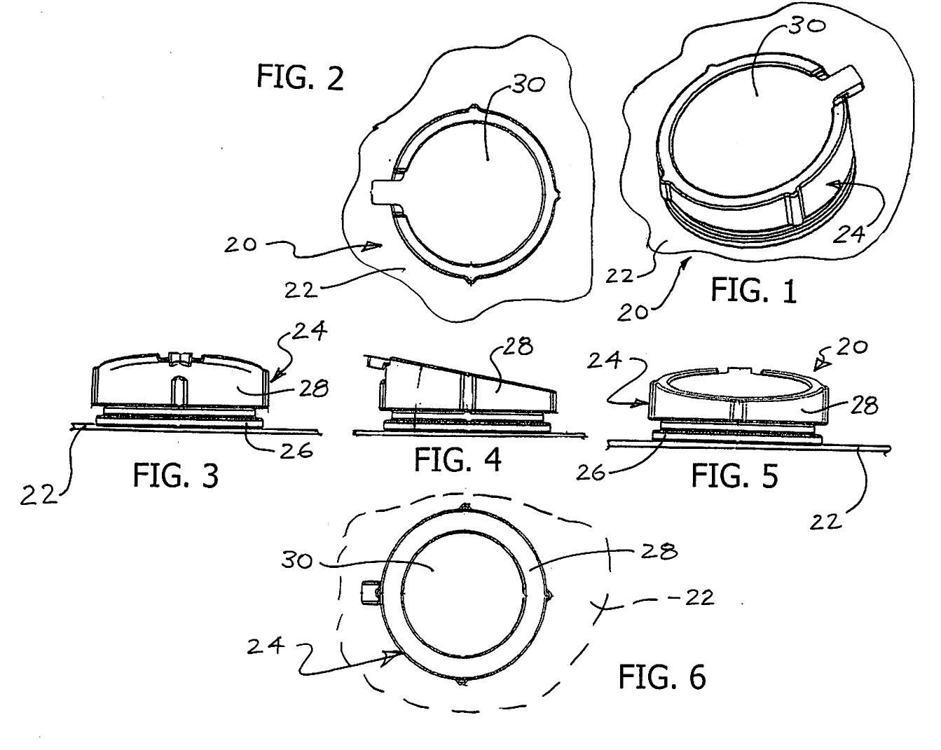

Turning now in detail to the drawings, as shown in FIGS. 1-6, a lens drape 20 includes a lens assembly 24 attached to a surgical drape 22. In the drawings, only the portion of the drape 22 surrounding the lens assembly 24 is shown. However, the drape 22 is dimensioned to cover a surgical microscope. The drape 22 may be a formed as tube or a bag. The lens assembly may have a diameter of e.g., about 8-15 cm. The size and shape of the drape 22 can vary depending on the type of microscope the lens drape 20 is to be used on.

The lens assembly 24 includes a drape ring 26, a lens ring 28 and a lens 30. These elements are shown assembled together in FIGS. 1-6. The drape ring 26 and the lens ring 28 are annular. The bottom surface 40 of the drape ring is attached to the drape 22, using adhesives, thermal bonding, or other generally permanent joining techniques. The drape material surrounded by the drape ring 26 is cut out and removed, leaving a round through opening having a diameter substantially equal to the inside diameter of the bottom surface 40 of the drape ring 26.

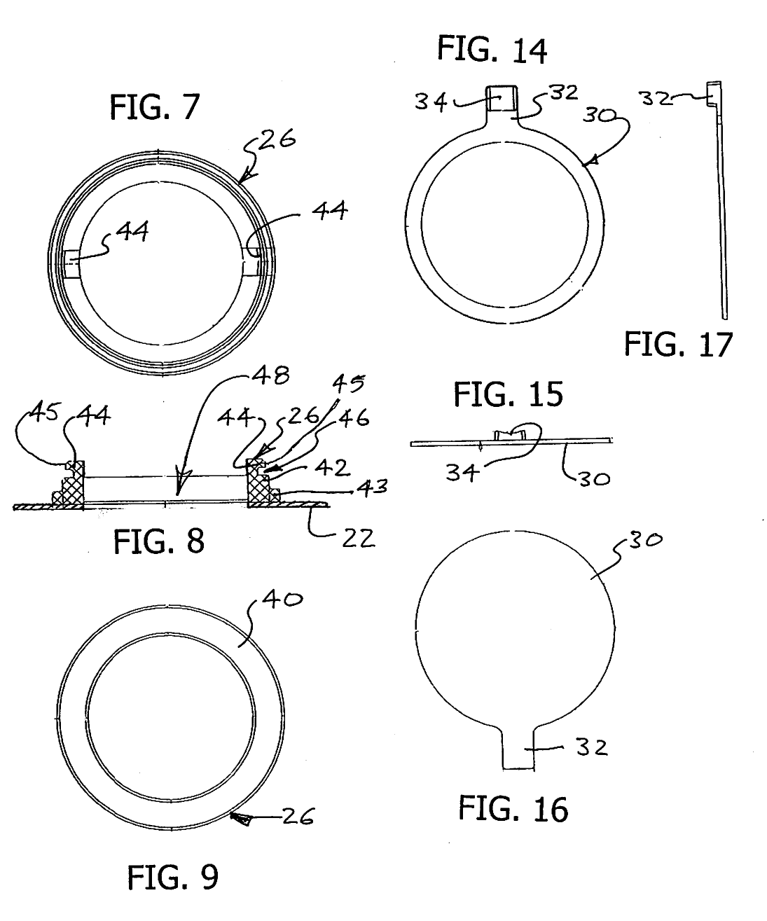

FIGS. 7-9 separately show the drape ring 26. The drape 22 is omitted from FIGS. 7 and 9 for purpose of illustration. The flat bottom surface 40 of the drape ring is attached to the drape 22. The drape ring 26 has an annular outer shoulder 43, and an annular inner shoulder 42 concentric with and vertically above the outer shoulder. In the design shown, the drape ring 26 includes two lugs 44 spaced apart from each other on opposite sides of the drape ring 26. Each lug 44 has an outwardly facing flange 45. A lug groove 46 is formed between each flange 45 and the top surface of the inner shoulder 42. The drape ring 26 (as well as the lens ring 28) has a central through opening 48. The drape ring 26 may be made of a plastic material.

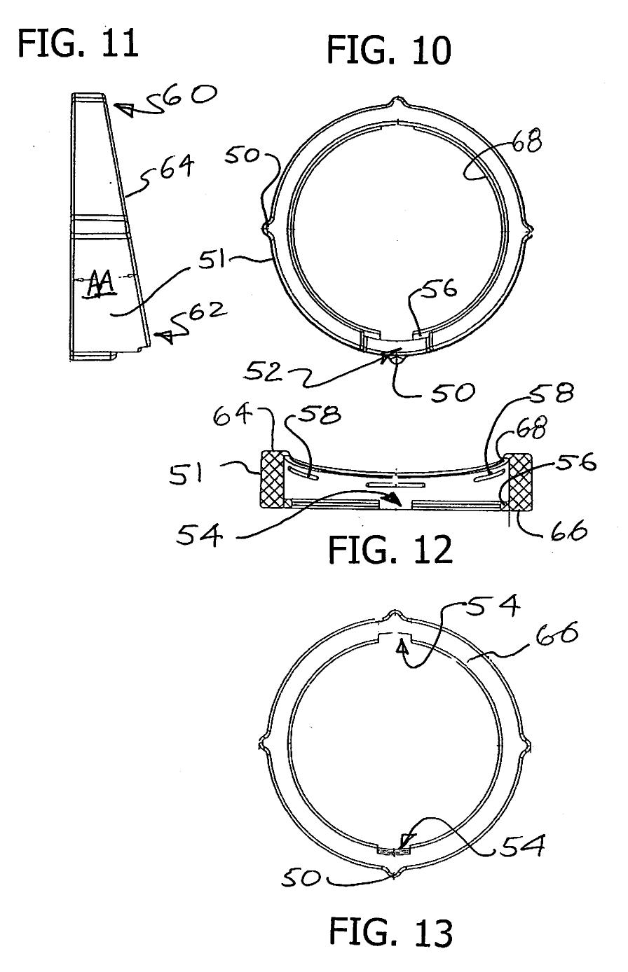

FIGS. 10-13 separately show the lens ring 28. The lens ring 28 may include cylindrical sidewalls 51 having spaced apart ridges 50. Features to facilitate grasping and rotating the lens ring may be added. As shown in FIG. 11, the top surface 64 may be oriented at an acute angle AA, relative to the bottom surface of the lens ring 28. The angle AA may range from about 5 to 25 or 8 to 15 degrees. The lens ring 28 accordingly has a high side 62 and a low side 60. A lens arm slot 52 may be provided in the top surface 64 of the lens ring 28, towards the high side 62 of the lens ring 28.

As shown in FIGS. 12 and 13, lug slots 54 extend vertically up from the bottom surface 66 of the lens ring 28. The lug slots 54 are dimensioned to accommodate the lugs 44 on the drape ring 26. The number and position of lug slots 54 on the lens ring 28 matches the number and position of the lugs 44 on the drape ring 26, so that the lens ring 28 may be engaged onto the drape ring 26. Referring to FIG. 12, an annular lug lip 56 extends radially inwardly at or near the bottom surface 66 of the lens ring 28. The lug lip 56 runs continuously around the lens ring 28, except where it is interrupted by the lug slots. The lug lip 56 is dimensioned to fit within the lug groove 46 on the drape ring 26. Referring still to FIG. 12, one or more lens support ledges 58 may be located towards the low side 60 of the lens ring 28, below the top surface 64 of the lens ring 28. A retainer ring or lip 68 can be provided above the lens support ledges 58, and extend partially or fully around the lens ring 28. The dimension between the lens support ledges 58 and the retainer lip 68 is selected to accommodate the lens 30. The lens ring 28 may be made of a resilient material, such as soft rubber.

As shown in FIGS. 14-17, the lens 30 is generally round with a diameter and thickness dimensioned to fit into the lens ring 28. A lens arm 32 having a finger tab 34 may be included to allow the lens 30 to be more easily removed from the lens ring 28. The lens 30 is typically a clear material, such as glass or plastic.

During manufacturing, the lens 30 can be manually pressed into the lens ring 28, with the lens 30 seating onto the lens support ledges 58. The resilient retainer lip 68 stretches slightly as the lens is pressed in, and then returns to its original position, holding the lens 30 in place. The lens arm 32, if used, extends through the lens arm slot 52, with the tab 34 facing down. The lens ring 28 is then attached to the drape ring 26 by aligning the lug slots 54 with the lugs 44 and pressing the lens ring 28 down onto the drape ring 26. The flange 45 of each lug 44 moves to a position slightly above the lug lip 56. The lens ring 28 is then rotated up to one-half turn, moving the lug slots 54 away from the lugs 44, with the lug lip 56 engaged in lug groove 46. This engagement holds the lens ring 28 and the lens 30 onto the drape ring 26, forming the lens assembly 24. A stop on the lug lip 56 may be provided to limit rotational movement. The drape 22 is joined onto the bottom surface of the 40 of the drape ring 26, with the drape 22 and the lens assembly 24 together forming the lens drape 20. The lens drape 20 is sterilized and packaged.

In use during surgery, the lens drape 20 is removed from the package and the drape 22 is placed over the surgical microscope. The lens assembly 24 is aligned over the objective lens of the microscope. Since the lens 30 is rotatable, the angular orientation of the lens 30 relative to the rest of the drape, or the microscope, is not important. The surgeon views the surgical site through the lens 30 using a surgical microscope. The angle AA of the lens tends to reduce glare, allowing the surgeon to better see the surgical site. The lens ring 28 holding the lens 30 may be rotated to reduce glare. Since the lens 30 is positioned at the angle AA, rotating the lens ring 28 changes the direction of light reflected off of the lens 30. This allows for glare reduction, regardless of the lighting and viewing angles. In addition, this glare-reducing adjustment is achieved without touching or adjusting the overhead lighting fixtures. If desired, the lens 30 can be quickly and easily removed from the lens ring 28 by grasping the lens arm 32 and lifting the lens out of the lens ring 28. In addition, the lens ring 28 may be removed from the drape ring 26, and from the lens drape 20, by turning the lens ring 28 to align the lugs 44 with the lug slots 54, and then pulling the lens ring 28 off.

A method of using a lens drape includes placing the lens drape over a surgical microscope, with the lens on the lens drape over the objective lens of the microscope. Light passes through the lens along a viewing axis. The surgeon views the surgical site through lens in the microscope, and through the drape lens. The drape lens is positioned at a non-perpendicular angle relative to the viewing axis. The drape lens is rotated as desired to reduce glare.

Thus, a novel lens drape has been shown and described. Various changes and substitutions may of course be made without departing from the spirit and scope of the invention. The invention, therefore, should not be limited, except by the following claims and their equivalents.

1. A lens drape for placement over a surgical microscope, comprising:
a drape;
a lens assembly attached to the drape, with the lens assembly including:
a drape ring having an upper surface and a lower surface, with the lower surface adhered to the drape, and two or more lugs extending upwardly from the upper surface;
a lens ring having a lower interior lug lip, including lug slots for allowing the lugs to rotatably engage the lug lip to assemble the drape ring onto the lens ring, the lens ring having one or more lens support ledges oriented in a plane forming an acute angle with the lower surface of the drape ring, when the lens ring is assembled onto the drape ring; and
a lens supported in the lens ring on the lens support ledges, and the lens having a lens arm extending through a lens arm slot in a top surface of the lens ring, with the lens removable from the lens ring by lifting the lens arm.

2. The lens drape of claim 1 further comprising spaced apart ridges on a cylindrical sidewall of the lens ring.

3. The lens drape of claim 1 with the lens ring comprising a deformable resilient material.

4. The lens drape of claim 1 with the lens ring engageable onto the drape ring by aligning the lug slots over the lugs and then rotating the lens ring.

5. The lens drape of claim 1 where the acute angle ranges from 5-25 degrees.

6. The lens drape of claim 1 with the lens resiliently held into the lens ring.

7. The lens drape of claim 1 with the lens substantially co-planer with an upper surface of the lens ring.

8. The lens drape of claim 1 further comprising a stop associated with a lower interior lug lip, for limiting rotation of the lens ring on the drape ring.

9. A lens drape for placement over a surgical microscope, comprising:
a drape;
a lens assembly attached to the drape, with the lens assembly including:
a drape ring having an upper surface and a lower surface, with the lower surface adhered to the drape, and two or more lugs extending upwardly from the upper surface;
a lens ring comprising a deformable resilient material, and having a lower interior lug lip, including lug slots for allowing the lugs to rotatably engage the lug lip to assemble the drape ring onto the lens ring, the lens ring having one or more lens support ledges oriented in a plane forming an acute angle with the lower surface of the drape ring, when the lens ring is assembled onto the drape ring;
a stop associated with a lower interior lug lip, for limiting rotation of the lens ring on the drape ring; and
a lens supported in the lens ring on the lens support ledges, and the lens having a lens arm extending through a lens arm slot in a top surface of the lens ring, with the lens removable from the lens ring by lifting the lens arm.

10. A drape for a surgical, comprising:
a drape;
a lens assembly including a drape ring and a lens ring holding a lens, with the drape attached to the drape, the lens ring holding the lens at an acute angle relative to the drape ring, and with the lens ring rotatable on the drape ring, to reduce glare during surgery.
